(19) United States
(12) Patent Application Publication
(10) Pub. No.: US 2003/0049352 A1
(43) Pub. Date: Mar. 13, 2003

(54) Fortified drinking water

(76) Inventors: Haile Mehansho, Fairfield, OH (US); Renee Irvine Mellican, Bradenton, FL (US); Raul Victorino Nunes, Loveland, OH (US); Adrian Monsalve Marcano, Caracas (VE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/150,328

(22) Filed: May 16, 2002

Related U.S. Application Data
(60) Provisional application No. 60/294,760, filed on May 31, 2001.

(51) Int. Cl. A23L 2/00

(52) U.S. Cl. 426/66

(57) ABSTRACT

A drinking water composition fortified with minerals and/or vitamins, including iron and zinc, having clarity, color and flavor improvements. The drinking water contains at least 5 ppm of a bioavailable iron compound which is stable to oxidation in the drinking water composition, without the need for excessive amounts of reducing agents or for fruit and/or botanical flavors and colorants to mask the metal taste or after-taste of the iron. Vitamins such as the B vitamins, vitamin A, vitamin C, and vitamin E can optionally be added to the drinking water. A method is disclosed for fortifying the drinking water with certain bioavailable zinc and iron compounds without producing undesirable clarity, color or metal taste or after-taste.

### CROSS REFERENCE

This application claims priority to Provisional Application Serial No. 60/294,760, filed May 31, 2001.

### TECHNICAL FIELD

The present invention relates to drinking water compositions supplemented with iron or zinc compounds, or mixtures of iron and zinc compounds that have excellent bioavailability. The drinking water containing the iron and zinc compounds does not have an off-flavor/aftertaste, is stable, and overcomes the problem of discoloration caused by the addition of these minerals to water. The compositions can also include optionally other minerals, vitamins, and other nutrients. The present invention further relates to packaged drinking water, preferably made from oxygen-barrier materials to ensure the stability of the mineral-fortified drinking water. The present invention further relates to a method of making the drinking water fortified with iron and zinc that avoids objectionable color, taste, and precipitates in the water.

### BACKGROUND OF THE INVENTION

In many countries, the average diet does not contain sufficient levels of iron, zinc, iodine, vitamin A or the B vitamins. Iron deficiency is well documented. Although iron deficiency is one of the few nutritional deficiencies in the U.S., it is common in most developing countries. Recent evidence suggests that nutritional zinc deficiency may be common among the people of many developing countries where they subsist on diets of plant origin (e.g. cereal and legume). Marginal zinc deficiency may be widespread even in the U.S. because of self-imposed dietary restrictions, use of alcohol and cereal proteins, and the increasing use of refined foods that decrease the intake of trace minerals.

Iron and zinc deficiencies can be overcome by taking supplements. Other methods of addressing these deficiencies include increasing the intake of foods naturally containing these minerals or fortifying food and beverage products. Usually, in countries where the people suffer from these deficiencies, the economy is such that providing minerals and vitamins as a supplement is expensive and presents significant distribution logistics problems. In addition, compliance, i.e., having the people take the vitamin and mineral supplements on a daily basis, is a serious problem. Accordingly, the delivery of iron and zinc along with other vitamins and minerals in a form that has high bioavailability and at the same time a non-objectionable taste and appearance, in a form that is soluble/completely dispersible, and in a form that would be consumed by a high proportion of the population at risk is desirable.

Vitamin and mineral fortified beverages and foods are known. Although substantial progress has been made in reducing iron deficiency by fortifying products such as infant formulas, breakfast cereals and chocolate drink powders, the formulations require milk that is often not available or affordable. To address the problem of iron and zinc deficiencies in the general population, efforts have been directed to formulating fruit-flavored dry beverage mixes supplemented with nutritional amounts (i.e., at least 5% of the USRDI) of zinc and iron with or without vitamins. Many fruit-flavored powdered beverages contain vitamins and/or minerals but seldom contain both zinc and iron at any significant level, see for example, Composition of Foods: Beverages, Agriculture Handbook No. 8 Series, Nutrition Monitoring Division, pgs 115-153.

There are well-recognized problems associated with adding both vitamins and minerals to beverages. These include poor solubility, stability, bioavailability, appearance and taste. Zinc supplements tend to have an objectionable taste, cause distortion of taste and cause mouth irritation. Iron supplements tend to discolor foodstuff, or to be organoleptically unsuitable. Moreover, it is particularly difficult to formulate products containing minerals and, in particular, mixtures of bioavailable iron and zinc. These minerals not only affects the organoleptic and aesthetic properties of beverages, but also undesirably affects the nutritional bioavailability of the minerals themselves and the stability of vitamins and flavors.

Several problems exist with delivering a mixture of iron and zinc with or without vitamins in a beverage mix. A few of the problems are choosing iron and zinc compounds which are organoleptically acceptable, bioavailable, cost effective and safe. For example, the water soluble iron and zinc compounds, which are the most bioavailable cause unacceptable metallic aftertaste and flavor changes. In addition, the soluble iron complexes often cause unacceptable color changes. Even further, the iron complexes themselves are often colored. This makes formulating a dry powder that has a uniform color distribution in the mix more difficult. Often the reconstituted beverage does not have a suitable color identifiable with the flavoring agent. If the color of the powder, reconstituted beverage or flavor of the beverage is substantially altered, the beverage will not be consumed. Color and taste are key to consumer acceptance.

### SUMMARY OF THE INVENTION

The inventors have surprisingly found that the ferrous ions (Fe²⁺) in drinking water compositions can be stabilized by reducing the redox potential of the water composition.

In accordance with a first aspect of the present invention, a drinking water composition is provided. The drinking water composition has a pH between about 5.0 and about 9.5, and comprises at least about 2 ppm of an iron compound substantially completely in the ferrous state, the water composition having a redox potential of less than about 200 mV.

In accordance with a second aspect of the present invention, a mineral-fortified drinking water composition is provided. The drinking water composition comprises at least about 2 ppm an iron compound selected from a water soluble iron compound, a water-dispersible particulate iron compound, and mixtures thereof, said iron compound being further selected from a complexed iron compound, a chelated iron compound, an encapsulated iron compound, and mixtures thereof, wherein the drinking water composition has a redox potential of less than about 700 mV, and a pH between about 2.5 and about 9.5; and wherein the taste of the drinking water composition, to which no optional flavors or sweeteners have been added, has no metallic taste or aftertaste.

In accordance with a third aspect of the present invention, a mineral-fortified drinking water composition is provided. The drinking water composition comprises at least 2 ppm an iron compound selected from a water soluble iron compound, a water-dispersible particulate iron compound, and mixtures thereof, wherein said iron compound being further selected from a complexed iron compound, a chelated iron compound, an encapsulated iron compound, and mixtures thereof, further wherein said drinking water composition is substantially free of a flavor or sweetener compound, and wherein said drinking water composition has no metallic taste or after-taste; a pH between about 2.5 and about 9.5; a Hunter colorimetric “b” reading of less than about 5.0; and an NTU turbidity value of less than about 5.0.

In accordance with a fourth aspect of the present invention, a packaged drinking water is provided. The packaged drinking water comprises

a. at least 2 ppm an iron compound selected from a water soluble iron compound, a water-dispersible particulate iron compound, and mixtures thereof, wherein said iron compound being further selected from a complexed iron compound, a chelated iron compound, an encapsulated iron compound, and mixtures thereof, wherein said drinking water composition is substantially free of a flavor or sweetener compound, and wherein the drinking water composition has no metallic taste or after-taste; a pH between about 2.5 and about 9.5; a Hunter colorimetric “b” reading of less than about 5.0; and an NTU turbidity value of less than 5.0; and

b. an oxygen-barrier package.

Also included within the scope of this invention are methods and process for the manufacture of drinking water compositions.

All patents, articles, documents, and other materials cited are, in relevant part, incorporated herein by reference; the citation of any document is not to be construed as an admission that it is prior art with respect to the present invention.

All percentages, ratios and proportions are by weight, and all temperatures are in degrees Celsius (° C.), unless otherwise specified. All measurements are in SI units, unless otherwise specified.

### DETAILED DESCRIPTION OF THE INVENTION

As used herein, the term “comprising” means various components conjointly employed in the preparation of the drinking water composition of the present invention. Accordingly, the terms “consisting essentially of’ and “consisting of’ are embodied in the term “comprising”.

As used herein, the terms “per serving”, “per unit serving” or “serving size” refers to 250 milliliters of the finished beverage.

The U.S. Recommended Daily Intake (USRDI) for vitamins and minerals are defined and set forth in the Recommended Daily Dietary Allowance-Food and Nutrition Board, National Academy of Sciences National Research Council, for a serving size of 250 mls of the drinking water composition. As used herein, a nutritionally supplemental amount of minerals other than iron or zinc is at least about 5%, preferably from about 10% to about 200%, of the USRDI of such minerals. As used herein, a nutritionally supplemental amount of vitamins is at least about 5%, preferably from about 20% to about 200%, more preferably from about 25% to 100%, of the USRDI of such vitamins.

It is recognized, however, that the preferred daily intake of any vitamin or mineral may vary with the user. For example, persons suffering with anemia may require an increased intake of iron. Persons suffering vitamin deficiencies or who have poor diets will require more vitamin A, vitamin C and vitamin B2, particularly growing children in developing countries. Such matters are familiar to physicians and nutritional experts, and usage of the compositions of the present invention may be adjusted accordingly.

The compositions of the present invention may not only be suitable for higher mammals, such as primates and humans, but may also be suitable for any animal or plant. The compositions of the present invention can be specifically tailored for the nutritional needs of a specific animal or plant, by the amount and/or which of minerals and/or vitamins are present. A nonlimiting example is one drinking water composition of the present invention could be formulated specifically humans, such as babies, preschool children and pregnant/lactating women, another could be formulated for household pets, such as a cat, and a third could be formulated specifically for indoor plants.

Iron Source

The iron compound of the present invention may be selected from a water-soluble iron compound, a water-dispersible particulate iron compound, and mixtures thereof. In addition, the iron compound of the present invention is more preferably selected from a complexed iron compound, a chelated iron compound, an encapsulated iron compound, and mixtures thereof. The iron compound should also be bioavailable to provide the health benefits herein before described.

A preferred iron compound can be added to a water source to provide an iron-fortified drinking water that reduces, and preferably eliminates the metallic taste and aftertaste that is typical of iron-containing waters and beverages. While not wanting to be limited by theory, it is beloved that the elimination of the metallic taste can be achieved by maintaining the iron compound substantially completely in the ferrous state and either encapsulating the iron compound, or by binding the iron into a stable compound by complexing or chelating with a suitable ligand that does not permit the iron to be freely associated in the drinking water while.

The inventors have discovered that a key factor in maintaining the stability of the ferrous state in the drinking water is the control of the redox potential of the drinking water. The various ions compounds in drinking water will undergo oxidation-reduction reactions, in an equilibrium state that is dictated by the redox potential of the water system. In the case of iron, ferric iron (Fe³⁺) can be reduced chemically to ferrous iron (Fe²⁺) in an equilibrium state, if a redox potential of about 770 mV or less is attained and maintained. Preferably, the redox potential is maintained below about 700 mV, more preferably below about 500 mV, even more preferably below about 300 mV, even more preferably still below about 200 mV, and yet even more preferably still below about 150 mV.

Preferred iron compound forms also include encapsulates and complexes that have a dispersed particle size in the drinking water that is small enough to be barely visible in solution. Preferably, the dispersed particle size is about 100 nanometers (nm) or less, and more preferably about 80 nm or less. A particularly preferred iron source is a stabilized, micron-sized iron complexed with pyrophosphate, available as SunActive Iron (Taiyo Company, Japan).

A iron compound form useful for the purpose of the present invention is ferrous sulfate encapsulated in a hydrogenated soybean oil matrix, for example, CAP-SHURE, available from Balchem Corp., Slate Hill, N. Y., and chelated iron (i.e., ferrous) wherein the chelating agent is an amino acid, for example, FERROCHEL AMINO ACID CHELATE, available from Albion Laboratories, Inc., Clearfield, Utah. Other solid fats can be used to encapsulate the ferric sulfate, such as tristearin, hydrogenated corn oil, cottonseed oil, sunflower oil, tallow and lard.

Ferrous amino acid chelates particularly suitable as highly bioavailable amino acid chelated irons for use in the present invention are those having a ligand to metal ratio of at least 2:1. For example, suitable ferrous amino acid chelates having a ligand to metal mole ratio of two (2) are those of formula “Fe(L)₂”, where L is an alpha amino acid, dipeptide, tripeptide or quadrapeptide reacting ligand. Thus, L can be any reacting ligand that is a naturally occurring alpha amino acid selected from alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine and valine or dipeptides, tripeptides or quadrapeptides formed by any combination of these alpha amino acids. See U.S. Pat. No. 3,969,540 (Jensen), issued Jul. 13, 1976 and U.S. Pat. No. 4,020,158 (Ashmead), issued Apr. 26, 1977; U.S. Pat. No. 4,863,898 (Ashmead et al), issued Sep. 5, 1989; U.S. Pat. No. 4,830,716 (Ashmead), issued May 16, 1989; and U.S. Pat. No. 4,599,152 (Ashmead), issued Jul. 8, 1986. Particularly preferred ferrous amino acid chelates are those where the reacting ligands are glycine, lysine, and leucine. Most preferred is the ferrous amino acid chelate sold under the Trade name FERROCHEL by Albion Laboratories where the reacting ligand is glycine.

Highly bioavailable food grade ferrous salts that can be used in the present invention include, but are not limited to, ferrous sulfate, ferrous fumarate, ferrous succinate, ferrous gluconate, ferrous lactate, ferrous tartrate, ferrous citrate, ferrous amino acid chelates, as well as mixtures of these ferrous salts.

Other bioavailable sources of iron particularly suitable for fortifying drinking water of the present invention include certain iron-sugar-carboxylate complexes. In these iron-sugar-carboxylate complexes, the carboxylate provides the counterion for the ferrous iron. The overall synthesis of these iron-sugar-carboxylate complexes involves the formation of a calcium-sugar moiety in aqueous media (for example, by reacting calcium hydroxide with a sugar, reacting the iron source (such as ferrous ammonium sulfate) with the calcium-sugar moiety in aqueous media to provide an iron-sugar moiety, and neutralizing the reaction system with a carboxylic acid (the “carboxylate counterion”) to provide the desired iron-sugar-carboxylate complex. Sugars that can be used to prepare the calcium-sugar moiety include any of the ingestible saccharidic materials, and mixtures thereof, such as glucose, sucrose and fructose, marmose, galactose, lactose, and maltose, with sucrose and fructose being the more preferred. The carboxylic acid providing the “carboxylate counterion” can be any ingestible carboxylic acid such as citric acid, malic acid, tartaric acid, lactic acid, succinic acid, propionic acid, etc., as well as mixtures of these acids.

These iron-sugar-carboxylate complexes can be prepared in the manner described in U.S. Pat. Nos. 4,786,510 and 4,786,518 (Nakel et al) issued Nov. 22, 1988. These materials are referred to as “complexes,” but they can, in fact, exist in solution as complicated, highly hydrated, protected colloids; the term “complex” is used for the purpose of simplicity.

The amount of iron compound added to the drinking water composition can vary widely depending upon the level of supplementation desired in the final product and the targeted consumer. The USRDI for iron generally range from about 10 mg to about 18 mg female or male, depending somewhat on age. The iron fortified compositions of the present invention typically contain at least about 2 ppm of iron compound, sufficient to deliver about 5% to about 100% USRDI of iron (based per serving) to account for iron that is available from other dietary sources (assuming a reasonably balanced diet). Preferably the compositions contain from about 15% to about 50%, and most preferably about 20% to about 40% of the USRDI for iron. In one embodiment of the present invention the drinking water composition comprises at least 2 ppm, more preferably at least 5 ppm, of iron.

Zinc Source

The zinc compounds used in the present invention can be in any of the commonly used forms such as the sulfate, chloride, acetate, gluconate, ascorbate, citrate, aspartate, picolinate, amino acid chelated zinc, as well as zinc oxide. It has been found, however, because of taste reasons, that zinc gluconate and amino acid chelated zinc are particularly preferred. The zinc fortified composition of the present invention typically contains at least 5 ppm of zinc chelate compound. Preferably, drinking water composition contains zinc compound to provide about 5% to about 100% USRDI of zinc (based per serving) to account for that which is available from other dietary sources (assuming a reasonably balanced diet). Preferably the compositions contain from about 15% to about 50% and, preferably from about 25% to 40% of the USRDI for zinc.

The zinc compound can also be an encapsultated zinc compound, utilizing encapsulating materials described herein above for the iron compound.

Preferred zinc compound forms also include encapsulates and complexes that have a dispersed particle size in the drinking water that is small enough to be barely visible in solution. Preferably, the dispersed particle size is about 100 nanometers (nm) or less, and more preferably about 80 nm or less.

Anions

The drinking water compositions of the present invention are preferably free of certain anions, either as counter ions to the iron and/or zinc, or as counter ions to other components of the compositions, such as copper or manganese. It is preferred that the compositions of the present invention be “substantially free” of any sulfide, that is and carbonate, that is, CO₃²⁻. By “substantially free”, it is meant that there is less than about 0.1% by weight of S²⁻, and less than about 0.1% by weight of CO₃²⁻, more preferably less than about 0.01% by weight of S²⁻, and less than about 0.01% by weight of CO₃²⁻, even more preferably about 0% by weight of S²⁻, and about 0% by weight of CO₃², present in the drinking water compositions of the present invention. However, it is to be understood that while these anions are not preferred, they still may be present in the compositions of the present invention.

Optional Ingredients:

Reducing Agent—These are compounds that have the ability of changing the oxidizing environment of the aqueous delivery system to the reducing environment by modulating the the redox potential (i.e., a reducing agent capable of reducing any ferric ion that is formed to ferrous ion can be used in the drinking water composition). These reducing agent can be used to reduce the redox potential of the water, or can be used as a reserve to reduce any iron compounds which might revert to the ferric state during storage. Suitable reducing agents include ascorbic acid, ascorbyl palmitate, sodium bisulfite, erythorbic acid, glutathione, taurine, arabinogalactan, maltodextrin, N-acetyl cysteine, glucose/glucoseoxidase and the salts thereof, as well as mixtures of these reducing agents. The key requirement is the standard redox potential of the reducing compound added should be lower than the nutrient being stabilized and made soluble The preferred reducing agents are n-acetyl cysteine, erythrobic acid simple polyphenolics/flavonoids and ascorbic acid.

Other Vitamins and Minerals—The drinking water composition of the present invention can optionally contain in addition to iron and/or zinc, other minerals, vitamins, and fibers, including, but not limited to, vitamin A, vitamin C, vitamin E, vitamin B12, vitamin B2, vitamin B6, vitamin D, folic acid, iodine, green tea extracts, thiamine, thiamin, niacin, fluoride, calcium, magnesium, selenium, copper, manganese and arabinogalactan. A one-unit portion (250 ml) of the drinking water composition provides from about 5% to about 200% of the USRDI for these other vitamin and mineral materials.

Current USRDI values for most healthy adults are generally: vitamin C (about 60 mg), vitamin A as retinol (about 1 mg) or as Beta-carotene (about 3 mg), vitamin B2 (about 1.7 mg), niacin (about 20 mg), thiamin (about 1.5 mg), vitamin B6 (about 2.0 mg), folic acid (about 0.4 mg), vitamin B12 (about 6 mg), vitamin E (about 30 international units) copper (about 1.6), manganese (about 2.3 mg) and for iodine about 150 mg.

Commercially available sources of vitamin C can be used herein. Encapsulated ascorbic acid and edible salts of ascorbic acid can also be used. Typically, from about 5% to about 200% of the USRDI of vitamin C is used in the drinking water composition. Preferably from about 25% to about 150%, and most preferably about 100% of the USRD1 for vitamin C is used in 35 g of the drinking water composition.

Commercially available vitamin A sources can also be incorporated into the drinking water composition. A single serving preferably contains from about 5% to about 100% and most preferably contains about 25% of the USRDI of vitamin A. Vitamin A can be provided, for example, as vitamin A palmitate (retinol palmitate) and/or as beta-carotene. It can be as an oil, beadlets or encapsulated. As used herein, “vitamin A” includes vitamin A, Beta-carotene, retinol palmitate and retinol acetate.

Commercially available sources of vitamin B2 (riboflavin) can be used herein. The resulting drinking water composition preferably contains (per serving) from about 5% to about 200% and most preferably contains from about 15% to about 35% of the USRDI of vitamin B2. Vitamin B2 is also called riboflavin. Commercial sources of iodine, preferably as an encapsulated iodine are used herein. Other sources of iodine include iodine containing salts, e.g., sodium iodide, potassium iodide, potassium iodate, sodium iodate, or mixtures thereof. These salts may be encapsulated.

Nutritionally supplemental amounts of other vitamins for incorporation into the drinking water composition include, but are not limited to, vitamins B6 and B12, folic acid, niacin, pantothenic acid, niacin amide, N-acetyl cysteine, folic acid, and vitamins D and E. Typically, the drinking water composition contains at least 5%, preferably at least 25%, and most preferably at least 35% of the USRDI for these vitamins. Other vitamins can also be incorporated into the drinking water composition depending on the nutritional needs of the consumers to which the drinking water product is directed.

Nutritionally supplemental amounts of polyunsaturated fatty acids (DHA, EPA), and immune enhancing amino acids including arginine and glutamine may also be included into the drinking water compositions of the present invention.

Nutritionally supplemental amounts of other minerals for incorporation into the drinking water composition include, but are not limited to, calcium compounds, manganese (II) compounds, and copper (I) compounds. Suitable copper (I) sources include, but are not limited to, copper (I) sulfate, copper(I) gluconate, copper(I) citrate, copper(I) amino acid chelates, such as, copper bis-glycinate. A preferred calcium source, when present, is a calcium citrate malate composition described in U.S. Pat. Nos. 4,789,510, 4,786,518 and 4,822,847. Suitable manganese (II) sources include, but are not limited to, manganese (II) sulfate, manganese (II) gluconate, manganese (II) citrate, manganese (II) oxide, manganese (II) amino acid chelates, such as, manganese bis-glycinate.

Coloring Agent—Small amounts of coloring agent, such as the FD&C dyes (e.g. yellow #5, blue #2, red #40) and/or FD&C lakes can be optionally used. Such coloring agents are added to the drinking water for aesthetic reasons only, and are not required to mask an off color or precipitation caused by the iron compound. By adding the lakes to the other powdered ingredients, any particles, in particular any iron compound particles, are completely and uniformly colored and a uniformly colored beverage mix can be attained. Preferred lake dyes that can be used in the present invention are the FDA approved Lake, such as Lake red #40, yellow #6, blue #1, and the like. Additionally, a mixture of FD&C dyes or a FD&C lake dye in combination with other conventional food and food colorants can be used. The exact amount of coloring agent used will vary, depending on the agents used and the intensity desired in the finished product. The amount of optional coloring agent can be readily determined by one skilled in the art. Generally the optional coloring agent, when present, may be present at a level of from about 0.0001% to about 0.5%, more preferably from about 0.004% to about 0.1% by weight of the composition. If the drinking water composition also contains an optional flavor agent, then if an optional coloring agent is used it is typically selected to compliment the flavor, e.g. yellow color for a. Additionally, riboflavin and/or Beta-carotene may be used as optional coloring agents.

Flavoring Agent—The drinking water may optionally comprise a flavoring agent consisting of any natural or synthetically prepared fruit or botanical flavors or with mixtures of botanical flavors and fruit juice blends. Such optional flavoring agents are added to the drinking water for aesthetic reasons only, and are not required to mask an metallic taste or after-taste caused by the iron compound. Suitable natural or artificial fruit flavors include lemon, orange, grapefruit, strawberry, banana, pear, kiwi, grape, apple, lemon, mango, pineapple, passion fruit, raspberry and mixtures thereof. Suitable botanical flavors include jamaica, marigold, chrysanthemum, tea, chamomile, ginger, valerian, yohimbe, hops, eriodictyon, ginseng, bilberry, rice, red wine, mango, peony, lemon balm, nut gall, oak chip, lavender, walnut, gentiam, luo han guo, cinnamon, angelica, aloe, agrimony, yarrow and mixtures thereof. The actual amount of flavoring agent will depend on the type of flavoring agent used and the amount of flavor desired in the finished beverage. Other flavor enhancers, as well as flavorants such as chocolate, vanilla, etc., can also be used.

Acid Component—An edible acid can optionally be added to the drinking water composition of the present invention. Such flavoring agents are added to the drinking water for aesthetic reasons only, and are not required to mask a metallic taste or after-taste caused by the iron compound. These acids may be used alone or in combination. The edible acid can be selected from tannic acid, malic acid, tartaric acid, citric acid, malic acid, phosphoric acid, acetic acid, lactic acid, maleic acid, and mixtures thereof.

Sweetener—The drinking water of the present invention can optionally comprise a sweetener. Such flavoring agents are added to the drinking water for aesthetic reasons only, and are not required to mask an metallic taste or after-taste caused by the iron compound. Suitable particulate sugars can be granulated or powdered, and can include sucrose, fructose, dextrose, maltose, lactose and mixtures thereof. Most preferred is sucrose. Artificial sweeteners can also be used. Often gums, pectins and other thickeners are used with artificial sweeteners to act as bulking agents and provide texture to the reconstituted dry beverage. Mixtures of sugars and artificial sweeteners can be used.

In addition to or in place of the added sugar in the drinking water composition, other natural or artificial sweeteners can also be incorporated therein. Other suitable sweeteners include saccharin, cyclamates, acesulfwn-K, L-aspartyl-L-phenylaianine lower alkyl ester sweeteners (e.g. aspartame), L-aspartyl-Dalanine amides disclosed in U.S. Pat. No. 4,411,925 to Brennan et al., L-aspartyl-D-serine amides disclosed in U.S. Pat. No. 4,399,163 to Brennan et al., L-aspartyl-L-1-hydroxymethylalkaneamide sweeteners disclosed in U.S. Pat. No. 4,338,346 to Brand, L-aspartyl-1-hydroxyethyalkaneamide sweeteners disclosed in U.S. Pat. No. 4,423,029 to Rizzi, L-aspartyl-D-phenylglycine ester and amide sweeteners disclosed in European Patent Application 168,112 to J. M. Janusz, published Jan. 15, 1986, and the like. A particularly preferred optional and additional sweetener is aspartame.

Antioxidant—The drinking water can further comprise a food grade antioxidant in an amount sufficient to inhibit oxidation of the aforementioned materials, especially lipids. Excessive oxidation can contribute to off-flavor development of these ingredients. Excessive oxidation can also lead to degradation and inactivation of any ascorbic acid or other easily oxidized vitamin or minerals in the mix.

Known or conventional food grade antioxidants can be used. Such food grade antioxidants include, but are not limited to, butylated hydroxyanisole (BHA), butylated hydroxytoluene (BHT), and mixtures thereof. Selection of an effective amount of a food grade antioxidant is easily determined by the skilled artisan. Limitations on such amounts or concentrations are normally subject to government regulations.

Package

The present invention further relates to packaged drinking water, comprising the drinking water composition of the present invention, packaged into a bottle or other container. Preferably, the package is made form a material that provides an oxygen barrier to prevent diffusion or leakage of air (containing oxygen) into the packaged drinking water. The package may be of a single material or it may be a composite, laminate or the like. Typically, the package will be for a single serving, that is it will contain 250 ml of the drinking water composition of the present invention, however packages containing multiple servings, such as a package containing 1L of the drinking water composition of the present invention, are within the scope of the present invention.

The package may be made of any suitable material. Suitable materials include, but are not limited to, polymers, such as, PET, POET and the like.

Preparation of the Drinking Water Composition

The drinking waters of the present invention can be prepared from a variety of water sources. Most preferred are deionized water, softened water, or distilled water. The water may also be subjected to filtration, such as reverse osmosis. The water may also be subject to a combination of these, such as distilled water which has been subjected to reverse osmosis.

The present invention provides a process step wherein the water source is treated to reduce its redox potential. One preferred treatment comprises removing/reducing the components that have higher standard redox potential than iron (Mn^{4+,}Cl₂, H₂O₂, NO₃) and deoxygenating the water to reduce the concentration of oxygen in the water, or to eliminate all dissolved oxygen. Preferred methods of deoxygenating the water include stripping of oxygen (and other dissolved gases) with nitrogen, carbon dioxide or other inert gas. Preferred as inert gases, such as nitrogen gas. Oxygen gas can also be reduced by heating the water to high temperatures, at which the solubility is reduced. Another method comprises adding reducing agents to the water, such as ascorbic acid.

It is preferred that the dissolved oxygen level in the source water is typically reduced to less than 5 ppm, preferably less than 3 ppm, and more preferably less than 1 ppm.

The deoxygenation process typically also removes other redox potential increasing agent, such as any dissolved halide gas, like chlorine gas, as well as volatile organic materials.

The iron compound, and/or zinc compound, is then admixed at the desired nutrient level, typically under mild stirring. Preferably, the admixing step is conducted under an inert gas blanket to exclude outside air and oxygen from the product. Any additional ingredients are also added at this stage.

The drinking water composition is packaged into glass or plastic bottles, or other suitable container. Preferably, the plastic material of the bottle is an oxygen-impermeable barrier.

Finally, twenty four hours after preparation of the composition the redox potential, hunter “b” value”, turbidity and/or pH are measured.

Measuring Redox Potential

Redox potential is a voltage obtained for a redox reaction relative to that of hydrogen, all reactants at standard state (1 M). The standard half reaction potential or Eₐ^{o} of an ion is measured relative to hydrogen at pH 0, 25° C. and 1 atmH₂ gas (i.e. the Eₐ^{o} for hydrogen reaction is zero). However, in many case it is impractical to measure against the hydrogen standard. Instead the measurement is performed against a Ag/AgCl reference electrode and a conversion factor is added to the result to generate the standard half reaction potential for an ion. For example, when a redox value is measured against the Ag/AgCl reference electrode at 25° C. the conversion factor of 199 added to the value measured to give the redox potential relative to hydrogen, i.e. Eₐ^{o}.

Overall redox potential, or ΔE, for any 2 redox pairs is calculated according to the following formula: ΔE=E^{o} electron acceptor−E^{o} electron donor

The redox potential of a drinking water composition can be obtained using any suitable commercially available instruments.

It is important to note that the redox potential of a drinking water composition is only measured twenty-four hours after the composition has been prepared.

Nephelometric Turbidity Unit (NTU)

Turbidity is a unit of measurement quantifying the degree to which light traveling through water is scattered by the suspended organic and inorganic particles, a measurement of the cloudiness in water samples. It is an indicator of solubility and complete dispersability. Turbidity is commonly measured in Nephelometric Turbidity Units (NTU). More information on nephelometers may be found in U.S. Pat. No. 4,198,161.

The turbidity of a drinking water composition can be obtained using any suitable commercially available instruments, such as a Hach 2100 AN Tubidimeter.

It is important to note that the turbidity of a drinking water composition is only measured twenty-four hours after the composition has been prepared.

Hunter Colorimetry

The well-known Hunter color scale system may be used herein to measure the color of the water. A complete technical description of the system can be found in an article by R. S. Hunter, “Photoelectric Color Difference Meter,” J. of the Optical Soc. of Amer., 48, 985-95 (1958). Devices specifically designed for the measurement of color on the Hunter scales are described in U.S. Pat. No. 3,003,388 to Hunter et al., issued Oct. 10, 1961. In general, Hunter color values are based upon measurements of tri-stimulus color, namely “L”, “a” and “b”. The Hunter “b” scale measures color hue and chroma between blue and yellow. The Hunter “b” value is the difference between a sample and a standard reference.

The Hunter “b” value of a drinking water composition can be obtained using any suitable commercially available instruments.

It is important to note that the Hunter “b” value of a drinking water composition is only measured twenty four hours after the composition has be prepared.

The following nonlimiting examples further illustrate the drinking water compositions of the present invention.

### EXAMPLES

All mounts of ingredients for examples A to H are in mg, except for water which is given in mls.

| Ingredient | A | B | C | D | E | F | G | H |
|---|---|---|---|---|---|---|---|---|
| Iron¹ | 19.6 | 22.5 | 22.5 | — | 22.5 | 22.5 | 22.5 | 22.5 |
| Zinc² | — | 6.9 | 6.9 | 10 | — | — | — | 6.8 |
| Copper³ | — | — | — | — | — | — | — | 0.01 |
| Manganese⁴ | — | — | — | — | — | — | — | 0.0017 |
| Vitamin B12 | — | — | 0.0006 | — | — | — | — | — |
| Vitamin B2 | — | — | — | — | — | — | — | — |
| Vitamin B6 | — | — | 0.2 | — | — | — | — | — |
| Folic Acid | — | — | 0.04 | — | — | — | — | — |
| Erythrobic Acid | — | — | 35 | — | — | — | — | — |
| Arabinoglactan | — | — | — | — | 4000 | — | — | — |
| Potassium Iodide | — | — | — | — | — | 0.002 | 0.002 | — |
| N-acetyl cysteine | — | — | — | — | — | — | 25 | — |
| Sodium Ascorbate | 67.9 | 28.1 | — | 67.9 | — | 60 | — | 60 |
| Water⁵ | Quantity sufficient to 250 ml | | | | | | | |
| Redox Potential | 29 | 7.6 | 175 | 75 | 215 | 30 | 42 | 100 |
| Hunter “b” value | 1.36 | 0.15 | 0.26 | 2.0 | 4.5 | 0.6 | 2.0 | 1.24 |
| Turbudity | 3.0 | 3.1 | 2.6 | 3.7 | 4.5 | 2.2 | 3.0 | 3.1 |
| pH | 5 | 6 | 7 | 8 | 7 | 7 | 7 | 7 |

¹Any suitable iron source, such as SunActive iron, or ferrous-bis-glycinate
²Any suitable zinc source, such as, zinc-bis-glycinate, zinc citrate or zinc ascorbate
³Any suitable copper source, such as, copper-bis-glycinate, copper citrate, or copper sulfate
⁴Any suitable manganese source, such as, manganese gluconate or manganese sulfate
⁵The water is deioniozed water and filtered by reverse osmosis.

### Example 2

### Drinking Water Composition

| Ingredient | Amount | |
|---|---|---|
| Ferrous bis-glycinate | 19.6 | mg |
| Sodium ascorbate | 60 | mg |
| Zinc bis-glycinate | 6.8 | mg |
| Potassium Iodide | 20 | μg |
| Vitamin A palmitate | 2 | mg |
| Niacin amide | 2 | mg |
| Vitamin E | 3 | mg |
| Folic acid | 0.04 | mg |
| B12 | 0.0006 | mg |
| B6 | 0.20 | mg |
| Na Ascorbate | 60 | mg |
| Water¹ | QS to 250 | ml |
| Hunter “b” value | 0.42 | |
| Turbidity | 3.1 | |
| Redox Potential | 30 | mV |
| pH | 6.5 | |

¹The water is deioniozed water and filtered by reverse osmosis.

### Example 3

Nitrogen gas is bubbled through one liter of deionized water under gentle stirring and a nitrogen blanket for 15 minutes. The resulting water has less than 3 ppm oxygen.

15 ppm of SunActive (stabilized iron-pyrophosphate particles) are added to the deoxygenated water and mixed under nitrogen blanket.

The drinking water is clear, colorless, and has no metallic taste or after-taste.

While particular embodiments of the present invention have been illustrated and described, it will be apparent to those skilled in the art that various changes and modifications may be made without departing from the spirit and scope of the invention, and it is intended to cover in the appended claims all such modifications that are within the scope of the invention.

What is claimed is:

1. A iron-containing water composition having a pH between about 5.0 and about 9.5, comprising at least about 2 ppm of an iron compound substantially completely in the ferrous state, the water composition having a redox potential of less than about 200 mV.

2. The water composition of claim 1, wherein the redox potential is less than about 150 mV.

3. The water composition of claim 1, further comprising less than about 3 ppm oxygen.

4. The drinking water composition of claim 1 wherein the iron compound is a water-dispersible iron compound and has a dispersed particle size of less than about 100 nanometers.

5. The drinking water composition of claim 1, further comprising an oxygen scavenging agent.

6. The drinking water composition of claim 1, further comprising less than about 3 ppm dissolved oxygen gas, and being substantially free of a redox potential increasing agent selected from an oxoanion salt, dissolved halide gas and an organic material.

7. The drinking water composition of claim 1, further comprising at least about 2 ppm of a zinc compound selected from the group consisting of a complexed zinc compound, a chelated zinc compound, and an encapsulated zinc compound, and mixtures thereof.

8. The drinking water composition of claim 7, further comprising at least one selected from the group consisting of iodine, fluoride, Cu+ salts, Mn2+ salts, vitamin C, vitamin B12, vitamin B2, vitamin B6, vitamin D, vitamin E, folic acid, niacin, vitamin A/beta-carotene, calcium, magnesium, glucosamine, selenium, polyunsaturated fatty acids and green tea extracts.

9. A mineral-fortified drinking water composition comprising at least about 5 ppm an iron compound selected from a water soluble iron compound, a water-dispersible particulate iron compound, and mixtures thereof, said iron compound being further selected from a complexed iron compound, a chelated iron compound, an encapsulated iron compound, and mixtures thereof, wherein the drinking water composition has a redox potential of less than about 700 mV, and a pH between about 2.5 and about 9.5; and wherein the taste of the drinking water composition, to which no optional flavors or sweeteners have been added, has no metallic taste or aftertaste.

10. The drinking water composition of claim 9 wherein the water-dispersible iron compound has a dispersed particle size of less than about 100 nanometers.

11. The drinking water composition of claim 9, having a redox potential of less than about 300 mV.

12. The drinking water composition of claim 11, having a redox potential of less than about 200 mV.

13. The drinking water composition of claim 12, having a redox potential of less than about 150 mV.

14. The drinking water composition of claim 9, comprising at least about 2 ppm an zinc compound selected from the group consisting of complexed zinc compounds, chelated zinc compounds, and encapsulated zinc compounds, and mixtures thereof, the compounds being further selected from a water soluble zinc compound and a water dispersible particulate zinc compound.

15. The drinking water composition of claim 9, wherein the pH is between about 5.0 and about 9.5.

16. A mineral-fortified drinking water composition comprising at least 5 ppm an iron compound selected from a water soluble iron compound, a water-dispersible particulate iron compound, and mixtures thereof, wherein said iron compound being further selected from a complexed iron compound, a chelated iron compound, an encapsulated iron compound, and mixtures thereof, further wherein said drinking water composition is substantially free of a flavor or sweetener compound, and wherein said drinking water composition has no metallic taste or after-taste; a pH between about 2.5 and about 9.5; a Hunter calorimetric “b” reading of less than about 5.0; and an NTU turbidity value of less than about 5.0.

17. The drinking water composition of claim 16, having a redox potential of less than about 700 mV.

18. The drinking water composition of claim 16, further comprising at least one selected from the group consisting of Zinc compounds, iodine, manganese (II) compounds, copper (I) compounds, vitamin A, vitamin C, vitamin B12, vitamin B2, vitamin B6, vitamin D, vitamin E, niacin and folic acid.

19. A packaged drinking water, comprising:
a. at least about 2 ppm an iron compound selected from a water soluble iron compound, a water-dispersible particulate iron compound, and mixtures thereof, wherein said iron compound being further selected from a complexed iron compound, a chelated iron compound, an encapsulated iron compound, and mixtures thereof, wherein said drinking water composition is substantially free of a flavor or sweetener compound, and wherein the drinking water composition has no metallic taste or after-taste; a pH between about 2.5 and about 9.5; a Hunter calorimetric “b” reading of less than about 5.0; and an NTU turbidity value of less than 5.0; and
b. an oxygen-barrier package.

20. The packaged drinking water of claim 19, wherein the drinking water composition has a redox potential of less than about 700 mV, and wherein the taste of the drinking water composition, to which no optional flavors or sweeteners have been added, has no metallic taste or aftertaste.
